(19) United States
(12) Patent Application Publication
(10) Pub. No.: US 2003/0231627 A1
(43) Pub. Date: Dec. 18, 2003

(54) Arbitration logic for assigning input packet to available thread of a multi-threaded multi-engine network processor

(76) Inventors: Rajesh John, Santa Clara, CA (US); Mike Morrison, Sunnyvale, CA (US)

Correspondence Address: Wilson & Ham, PMB : 348, 2530 Berryessa Road, San Jose, CA, 95132, US

(21) Appl. No.: 10/425,695

(22) Filed: Apr. 28, 2003

Related U.S. Application Data
(60) Provisional application No. 60/385,980, filed on Jun. 4, 2002.

(51) Int. Cl. H04L 12/28; H04L 12/56

(52) U.S. Cl. 370/389

(57) ABSTRACT

A network processor having a plurality of processing engines and packet assignment logic operable to selectively assign the received packets to the processing engines is disclosed. The packet assignment logic of the network processor distributes the received packets according to at least in part the packet size of previously distributed packets. In one embodiment, the packet assignment logic does not assign any packets to a processing engine that is already assigned a “large” packet. In this way, load balancing among the processing engines is improved, resulting in a higher performance network processor.

### CROSS-REFERENCE TO RELATED APPLICATIONS

This application is entitled to the benefit of provisional Patent Application Serial Number 60/385,980, filed Jun. 4, 2002, which is hereby incorporated by reference. This application is related to co-pending application Serial Number (TBD), filed herewith, entitled “NETWORK PROCESSOR WITH MULTIPLE MULTI-THREADED PACKET-TYPE SPECIFIC ENGINES” and bearing attorney docket number RSTN-031-1.

### FIELD OF THE INVENTION

The invention relates generally to computer networking and more specifically to a network processor for use within a network node.

### BACKGROUND OF THE INVENTION

As demand for data networking around the world increases, network routers/switches have to contend with faster and faster data rates. At the same time the number of protocols that the network routers/switches must support is increasing. Thus, network routers/switches must increase their performance and make optimizations in many areas in order to cope with these demands.

In conventional routers/switches, network processors are used for enhancing the routers/switches' performance. Such network processors, whose primary functions involve generating forwarding information, sometimes waste a significant amount of processing time choosing the correct codes when processing different types of packets.

Packet size can also affect the performance of conventional network processors. Most conventional network processors are single-threaded, and they can handle only one packet a time. Thus, when the network processor is processing a large packet, other packets may be stalled for a long time.

In view of the growing demand for higher performance network routers/switches, what is needed is a network processor that can handle different networking protocols and yet does not spend significant amount of processing time selecting the appropriate codes for execution. What is also needed is a network processor that does not necessarily stall smaller packets while processing large packets.

### SUMMARY OF THE INVENTION

An embodiment of the invention is a network processor having a plurality of processing engines and packet assignment logic operable to selectively assign the received packets to the processing engines. The packet assignment logic distributes the received packets according to at least in part the packet size of previously distributed packets. In one embodiment, the packet assignment logic does not assign any packets to a processing engine that is already assigned a “large” packet. In this way, load balancing among the processing engines is improved, resulting in a higher performance network processor. In the descriptions herein, a “large” packet is a packet whose size exceeds a predetermined threshold.

In one embodiment, the processing engines are multi-threaded. According to this embodiment, available threads of a processing engine will not be assigned a packet if any one of its threads is already assigned a large packet.

According to one embodiment, the processing engines are configurable for different types of input packets. The processing engines can be classified into different groups where each group is responsible for processing one type of input packets. The packet assignment logic, in addition to determining the packet size of the input packets, checks the packet-type of a received packet and assigns the received packet to one of the processing engines within the appropriate group. The processing engines may be structurally identical but may be programmed to handle different types of packets with different microcode.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 depicts an architecture of a network processor in accordance of an embodiment of the invention.

FIG. 2 depicts a flow diagram depicting some operations of the network processor of FIG. 1 in accordance with an embodiment of the invention.

FIG. 3 depicts a portion a network processor according to one embodiment of the invention.

FIG. 4 is a flow diagram depicting some operations of the network processor shown in FIG. 3 according to this embodiment

FIG. 5 depicts a receiver buffer in accordance with an embodiment of the invention.

FIG. 6 depicts details of a network node in which an embodiment the invention can be implemented.

Throughout the description, similar reference numbers may be used to identify similar elements.

### DETAILED DESCRIPTION OF THE INVENTION

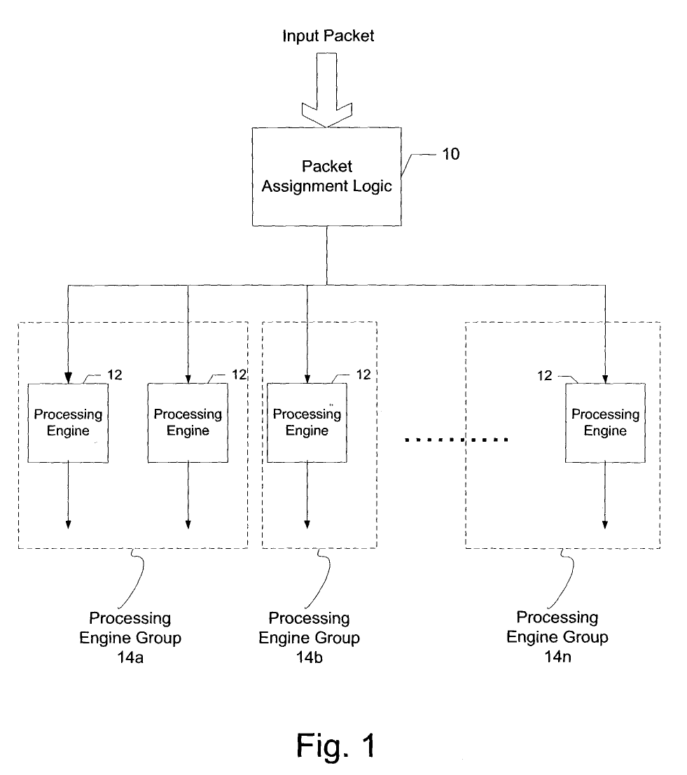

FIG. 1 depicts an architecture of a network processor in accordance of an embodiment of the invention. As shown, the network processor includes Packet Assignment Logic 10 and a plurality of Processing Engines 12. The Packet Assignment Logic 10 is configured to receive input packets (from an external source or from another portion of the network processor) and to obtain the packet type of the received packets. The Processing Engines 12 can be single-threaded or multi-threaded. In one embodiment where the Processing Engines 12 are single-threaded, the Packet Assignment Logic 10 is configured to distribute or assign the received packets to an appropriate one of the Processing Engines 12. In one embodiment where the Processing Engines 12 are multi-threaded, the Packet Assignment Logic 10 is configured to distribute or assign the received packets to an appropriate thread of an appropriate one of the Processing Engines 12.

In one embodiment, the Processing Engines 12 are classified into a number of different Processing Engine Groups 14a-14n. Each Processing Engine Group, which may include a variable number of Processing Engines, is configured to handle one type of packets. In other words, every Processing Engine 12 within the same group is configured to handle the same type of packets. For example, the Processing Engines of Processing Engine Group 14a may be configured to handle AAL5 (ATM Adaption Layer) frames while the Processing Engine of Processing Engine Group 14b may be configured to handle POS (Packet Over SONET) frames. In one embodiment, the Processing Engines 12 are structurally similar, and they can be programmed to handle different packet types by microcode. In another embodiment, the Processing Engines 12 can be structurally identical although the codes they execute to process the different packet types can be different.

Single-threaded programmable processing engine cores and multi-threaded programmable processing engine cores are also well known in the art. Therefore, details of such circuits are not described herein to avoid obscuring aspects of the invention.

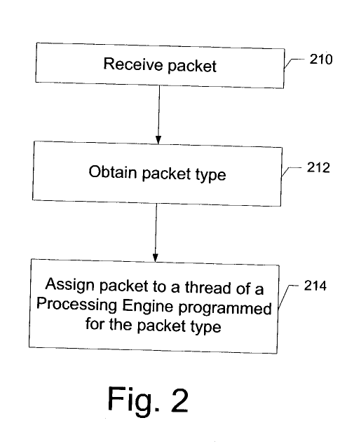

FIG. 2 depicts a flow diagram for operations of the Packet Assignment Logic 10 of FIG. 1 in accordance with an embodiment of the invention. As shown, at step 210, the Packet Assignment Logic 10 receives a packet. As used herein, the term “packet” refers to any block of data of fixed or variable length which is sent or to be sent over a network.

At step 212, the Packet Assignment Logic 10 obtains the packet type of the received packet. In one embodiment, the received packets can be one of a plurality of predetermined types. For example, the network processor can be configured for four different packet types: AAL5 frames, POS frames, Ethernet and Generic Framing Protocol (GFP). In other embodiments, the network processor can be configured to process other standard or user-defined packet types in addition to or in lieu of the aforementioned.

In one embodiment, the Packet Assignment Logic 10 obtains packet type information by checking control information affixed to the packet data. The control information may be affixed to or inserted into the packet data by logic circuits that are external to the network processor. In another embodiment, the Packet Assignment Logic 10 obtains the packet type information checking various fields of the packet data.

At step 214, the Packet Assignment Logic 10, having obtained the packet type of the received packet, assigns the packet to a thread of a Processing Engine 12 that is programmed for the specific packet type.

In one embodiment the illustrated steps 210-214 can be pipe-lined. For example, the Packet Assignment Logic 10 can be obtaining the packet type information of one packet while assigning another packet to a Processing Engine 12 at the same time. Additionally, the Packet Assignment Logic 10 can be executing the illustrated steps concurrently on multiple packets. For example, the Packet Assignment Logic 10 can be obtaining packet type information for multiple packets at the same time.

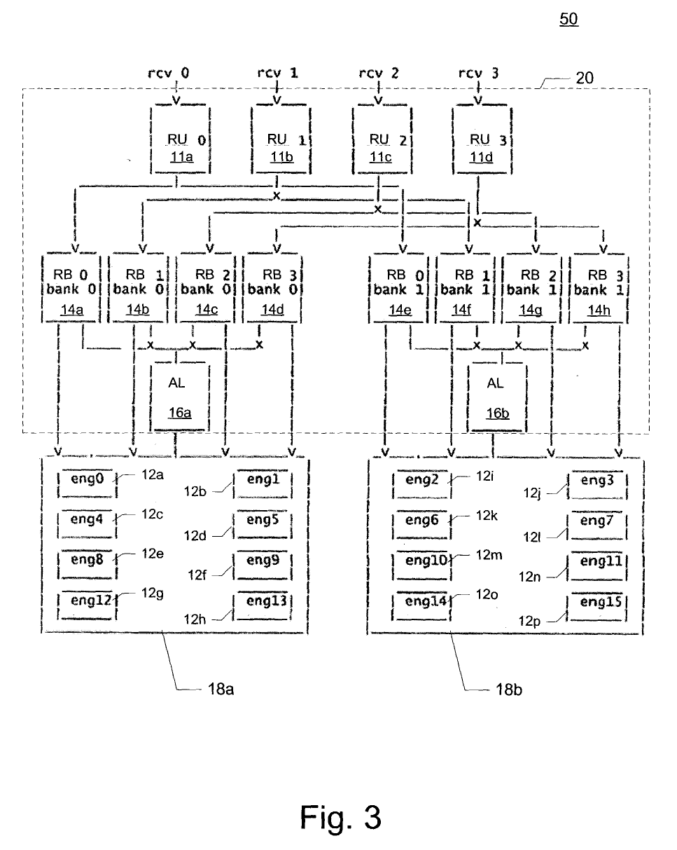

Referring now to FIG. 3, there is shown a portion a network processor 50 according to one embodiment of the invention. In this embodiment, the network processor 50 includes a Packet Assignment Logic 20, which includes four Receiver Units (RU) 11a-11d, eight Receiver Buffers (RB) 14a-14h, and two Arbitration Logic Circuits (AL) 16a-16b. The network processor 50 also includes two Processing Engine Banks 18a-18d, each containing eight Processing Engines 12. Receiver Buffers 14a-14d are associated with Processing Engine Bank 18a, and Receiver Buffers 14e-14h are associated with Processing Engine Bank 18b. Processing Engines 12a-12h of one Bank 18a receive packet data from Receiver Buffers 14a-14d, and Processing Engines 12i-12p of the other Bank 18b receive packet data from Receiver Buffers 14e-14h. In one embodiment, the Processing Engines 12 are implemented within the same integrated circuit.

In one embodiment of the invention, the Receiver Units 11a-11d receive packet data from an external high-speed interconnect bus. In one implementation where the high-speed interconnect bus is 40-bit wide, each Receiver Unit has a 10-bit wide input interface. In this implementation the output interface of each Receiver Units, however, is 40-bit wide. This is because the clock rate of the high-speed interconnect bus is higher than that of the Receiver Units. The outputs of each Receiver Unit are connected to one Receiver Buffer associated with Processing Bank 18a and to another Receiver Buffer associated with Processing Engine Bank 18b.

In one embodiment, only eight of the ten bits received by each Receiver Unit are used for packet data. The remaining eight bits of each 40-bit word, also called control data bits herein, are used to indicate the status of the 32-bit word. For example, the control data bits can indicate to which Processing Engine Bank the Receiver Unit must send the packet data. The control data bits can also indicate to the Receiver Unit that the packet data can be sent to either one of the Processing Engine Banks 18a-18b. In one embodiment, if packet data can be sent to either one of the Processing Engine Banks, the Receiver Unit will send the packet data in a round-robin fashion so that load-balancing can be achieved. In another embodiment, the Receiver Unit can use a predetermined hash function to hash predetermined fields of the packet data to determine where the packet data should be sent.

In one embodiment, the control data bits indicate the packet type of the packet data. In this embodiment, the control data bits, together with the configuration of the Processing Engine Groups, control where the Receiver Units 11a-11d should distribute or assign the packet data. For example, if the control data bits of a packet indicate that the packet is an AAL5 frame, and if all Processing Engines programmed to handle AAL5 packets are all located on Bank 18b, the Receiver Unit 11a will assign the packet data to Receiver Buffers 14e-14h, which are associated with Bank 18b.

In one embodiment, when a Receiver Buffer receives packet data from a Receiver Unit, the Receiver Buffer will store the packet data in packet-type-specific queues and will indicate to the Arbitration Logic Circuit (via one or more control signal lines) that there is pending data of a specific type. Further, when a thread of a Processing Engine is available, the Processing Engine will indicate to the Arbitration Logic Circuit (via one or more control signal lines) that a thread is available. The Arbitration Logic Circuit then selects the available thread and sends appropriate control signals (e.g., data bus control signals) to the Receiver Buffer so that the Receiver Buffer can send the pending packet data directly to the available thread.

In one embodiment, the Processing Engines 12 are packet-type specific. Thus, if the pending data is of one packet type, and if the available Processing Engine is programmed for that packet type, the Arbitration Logic Circuit will select the available thread and send appropriate data bus control signals to the Receiver Buffer. However, the Arbitration Logic Circuits 16a-16b will not select an available thread if the corresponding Processing Engine is not configured to handle the right type of packet. In this way, a Processing Engine can be programmed to handle one dedicated packet type. As a result, the processing cycles required in the prior art for choosing the correct codes to execute can be substantially reduced or eliminated.

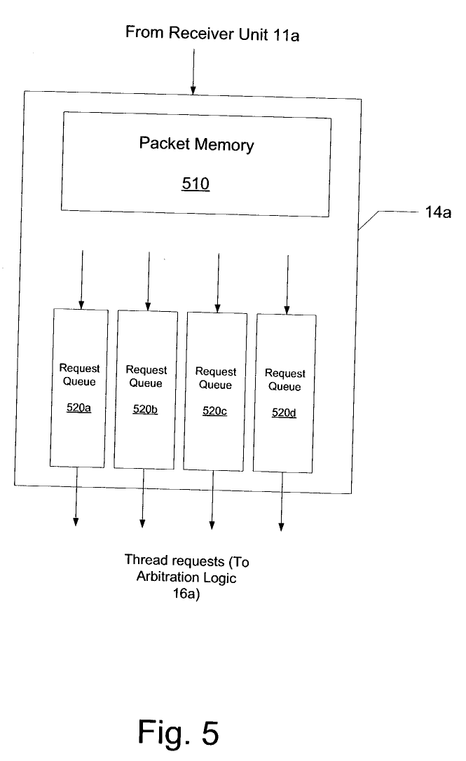

FIG. 5 depicts portions of a Receiver Buffer 14a in accordance with an embodiment of the invention. As shown the Receiver Buffer 14a has a Packet Memory 510 for storing packet data and a plurality of Request Queues 520a-520d. In the illustrated embodiment, the number of Request Queues corresponds to the number of different predetermined packet types that the Processing Engines of Bank 18a are designed to handle. In other words, each Request Queue is used for storing requests for one of the Processing Engine Groups of Bank 18a. For example, suppose Processing Engines 12a-12d are programmed to handle AAL5 frames and suppose Processing Engines 12e-12h are programmed to handle POS frames, the Receiver Buffer 14a will have at least two Request Queues to handle thread requests for these two groups of Processing Engines.

When the Receiver Buffer 14a receives packet data from the Receiver Unit 11a, it will store the packet data in the Packet Memory 510. The Receiver Buffer 14a will also obtain a packet type from the received packet data and stores a request in the appropriate Request Queue. In one embodiment, the request will be provided to the Arbitration Logic Circuit 16a, which will then select one of the Processing Engines or an available thread of one of the Processing Engines to process the request. The Processing Engines in turn will retrieve the packet data from the Packet Memory 510 for processing. In one embodiment, the Processing Engines are capable of “cell-based” processing. That is, the packet data is retrieved and processed by a Processing Engine one “cell” or one “portion” at a time.

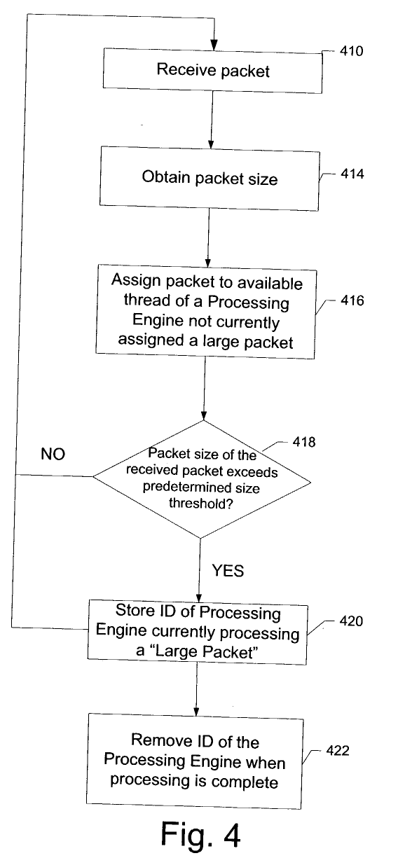

According to another aspect of the invention, the network processor avoids assigning packets to Processing Engines that are already occupied with large packets even if threads of those Processing Engines are available. FIG. 4 is a flow diagram depicting operations of the Packet Assignment Logic 20 of the network processor 50 according to this embodiment. As shown, at step 410, the Packet Assignment Logic 20 receives an input packet. At step 414, the Packet Assignment Logic 20 obtains the packet size of the received packet. In one embodiment, the Packet Assignment Logic 20 determines the packet size by examining the packet's header.

At step 416, the Packet Assignment Logic 20 assigns the packet to an available thread of a Processing Engine 12 whose threads are not currently assigned any “large packets.” A “large packet” herein refers to a packet whose size exceeds a predetermined size threshold. The size threshold is dependent upon the number of threads of each Processing Engine, the number of Receiver Units in the network processor, the size of the Receiver Buffers, and the average number of clock cycles required for a Processing Engine to process one packet. For the network processor 50 of FIG. 3, the size threshold can be estimated by the formula: P=(F/4)−L, where P is the size threshold, F is the buffer size of a Receiver Buffer, and L is the average number of clock cycles required for a Processing Engine to process a packet. An example size threshold for the network processor 50 of FIG. 3 is 400 bytes.

At decision point 418, the Packet Assignment Logic 20 determines whether the received packet is a large packet. If the received packet is not a large packet, the Packet Assignment Logic 20 can assign a newly received packet to a different thread of the same Processing Engine. However, if the received packet is a large packet, the Packet Assignment Logic 20 stores an identifier in its memory (not shown) to indicate that the Processing Engine is currently assigned a large packet at step 420. As a result, the Packet Assignment Logic 20 will not assign other packets to that Processing Engine. At step 422, after the Processing Engine has finished processing the current packet, the Packet Assignment Logic 20 clears the identifier such that the Processing Engine can begin to accept newly received packets.

The Processing Engine may have threads available to process other packets while processing a large packet. However, according to this embodiment, the Packet Assignment Logic 20 will not assign any packets to the Processing Engine as long as it is assigned a large packet unless no other Processing Engines are available. In this way, stalling of the network processor can be substantially reduced.

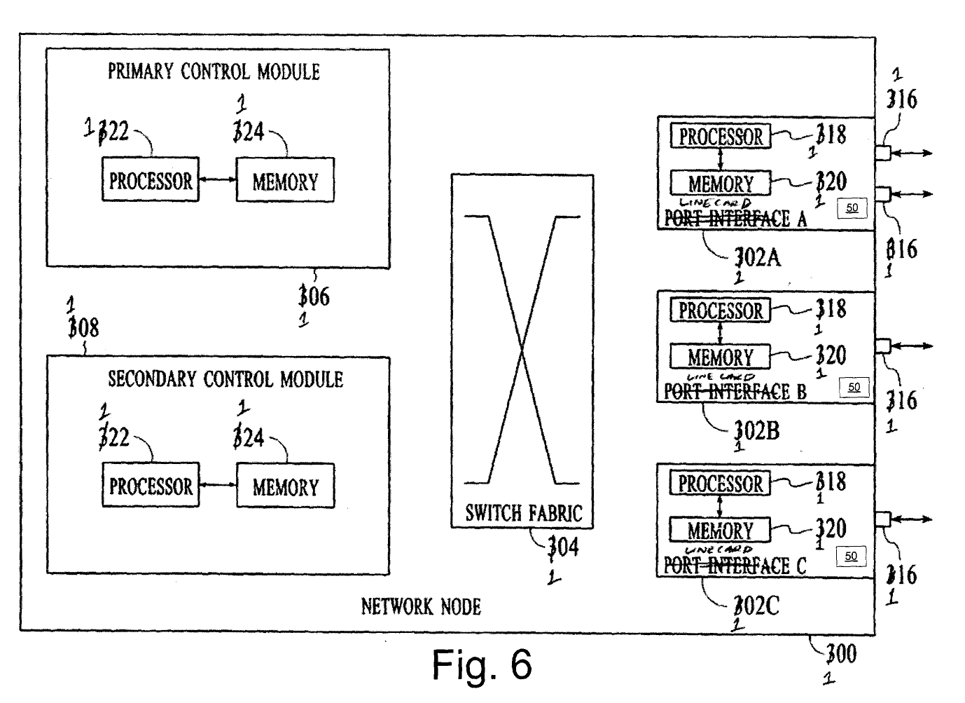

The invention can be implemented within a network node such as a switch or router. FIG. 6 illustrates details of a network node 100 in which an embodiment of the invention can be implemented. The network node 100 includes a primary control module 106, a secondary control module 108, a switch fabric 104, and three line cards 102A, 102B, and 102C (line cards A, B, and C). The switch fabric 104 provides datapaths between input ports and output ports of the network node 100 and may include, for example, shared memory, shared bus, and crosspoint matrices.

The line cards 102A, 102B, and 102C each include at least one port 116, a processor 118, and memory 120. The processor 118 may be a multifunction processor and/or an application specific processor that is operationally connected to the memory 120, which can include a RAM or a Content Addressable Memory (CAM). Each of the processors 118 performs and supports various switch/router functions. Each line card also includes a network processor 50. A primary function of the network processor 50 is to decide where a packet received through port 116 is to be routed.

The primary and secondary control modules 106 and 108 support various switch/router and control functions, such as network management functions and protocol implementation functions. The control modules 106 and 108 each include a processor 122 and memory 124 for carrying out the various functions. The processor 122 may include a multifunction microprocessor (e.g., an Intel i386 processor) and/or an application specific processor that is operationally connected to the memory. The memory 124 may include electrically erasable programmable read-only memory (EEPROM) or flash ROM for storing operational code and dynamic random access memory (DRAM) for buffering traffic and storing data structures, such as forwarding information.

Although specific embodiments of the invention have been described and illustrated, the invention is not to be limited to the specific forms or arrangements of parts as described and illustrated herein. For instance, it should also be understood that throughout this disclosure, where a software process or method is shown or described, the steps of the method may be performed in any order or simultaneously, unless it is clear from the context that one step depends on another being performed first. The invention is limited only by the claims.

What is claimed is:

1. A network processor, comprising:
a plurality of processing engines; and
packet assignment logic operable to ascertain packet size of received packets and to selectively assign the received packets to the processing engines, wherein the packet assignment logic distributes the received packets according to at least in part packet size of previously distributed packets.

2. The network processor of claim 1, wherein the packet assignment logic is operable to distribute the received packets to selected threads of the processing engines.

3. The network processor of claim 2, wherein the processing engines are programmable by microcode to process packets belonging to a plurality of packet types.

4. The network processor of claim 3, wherein the packet assignment logic is operable to selectively assign two received packets of identical type to different threads of a same one of the processing engines provided none of the two received packets exceeds a predetermined size.

5. The network processor of claim 1, wherein the plurality of processing engines comprise a plurality of multi-threaded processing engines.

6. A network processor, comprising:
a plurality of processing engines; and
packet assignment logic operable to ascertain a size of a first received packet, to selectively assign the first received packet to a first thread of a first one of the processing engines, and to avoid distributing a second received packet to the first processing engine if the first received packet exceeds a predetermined size.

7. The network processor of claim 6, wherein the packet assignment logic is operable to distribute the second received packet to a second thread of the first processing engine if the first received packet does not exceed the predetermined size.

8. The network processor of claim 7, wherein the processing engines are programmable by microcode to process packets belonging to a plurality of packet types.

9. The network processor of claim 8, wherein the packet assignment logic selectively assigns the received packets based on at least in part packet type of the received packets.

10. The network processor of claim 8, wherein a first group of the plurality of processing engines are programmed to process packets of a first type.

11. The network processor of claim 10, wherein a second group of the plurality of processing engines are programmed to process packets of a second type.

12. The network processor of claim 9, wherein the processing engines comprise a plurality of multi-threaded processing engines.

13. The network processor of claim 8, wherein the first packet and the second packet belong to a same packet type.

14. The network processor of claim 8, wherein the first processing engine and the second processing engine are similarly programmed for a same packet type.

15. A method of processing packet data within a network processor, comprising:
receiving a first packet;
assigning the first packet to a first thread of a first one of a group of processing engines;
ascertaining a packet size of the first packet;
receiving a second packet;
provided the first packet does not exceed a predetermined size, assigning the second packet to a second thread of the first processing engine; and
provided the first packet exceeds a predetermined size, assigning the second packet to a thread of a second one of the group of processing engines.

16. The method of claim 15, further comprising:
receiving a third packet; and
assigning the third packet to another group of processing engines if the first packet belongs to a first type and the third packet belongs to a second type.

17. The method of claim 16, further comprising ascertaining a packet type of the first packet and ascertaining a packet type of the third packet.

18. A method of processing packet data within a network processor, comprising:
receiving a plurality of packets;
ascertaining a size of each of the received packets; and
assigning the received packets to a plurality of processing engines of the network processor according to at least in part the sizes of the received packets.

19. The method of claim 18, wherein the assigning comprises:
ascertaining a type of each of the received packets; and
assigning the received packets to the processing engines according to at least in part the types of the received packets.

20. The method of claim 18, wherein the assigning comprises assigning the received packets to one or more threads of the processing engines.
